(19) United States
(12) Patent Application Publication
(10) Pub. No.: US 2026/0339361 A1
(43) Pub. Date: Oct. 29, 2026

(54) ERGONOMIC LAPTOP COMPUTER SYSTEM WITH AUTOMATICALLY ADJUSTABLE SCREEN

(71) Applicants: Mohamed Sherif Sirajudeen, Pollachi (IN); Ravi KUMAR. C, Pollachi-Coimbatore District (IN)

(72) Inventors: Mohamed Sherif Sirajudeen, Pollachi (IN); Ravi Kumar. C

(73) Assignee: Mohamed Sherif Sirajudeen, Pollachi (IN)

(21) Appl. No.: 19/099,033

(22) PCT Filed: Jul. 20, 2023
(86) PCT No.: PCT/IB2023/057386

§ 371 Date: Jan. 27, 2025

(30) Foreign Application Priority Data
Jul. 25, 2022 (IN) 202241042582

(51) Int. Cl. G05D 3/20; G06F 3/01; G06F 3/02

(52) U.S. Cl. CPC G05D 3/20; G06F 3/011; G06F 3/02

(57) ABSTRACT

An ergonomic laptop/portable computer system is provided according to an aspect of the present invention. In an embodiment, the ergonomic portable computer system comprises a processing unit, an input unit placed on a base and a display system comprising a display screen whose height from the base and the distance from a user can be adjusted, the display system operating to ensure that the height and distance are according to one or more ergonomic standards. In one embodiment, the one or more ergonomic standards include positioning the display screen at a height slightly below the eye-level of the user and at a one-arm distance from the user. Accordingly, the ergonomic laptop helps the users to adopt a healthy neck and upper limb postures and thereby reduces the risk of Musculo-skeletal disorders in individual users.

### PRIORITY CLAIM

This application claims priority to the India provisional patent application: 202241042582, filed on: 25 Jul. 2022 and PCT provisional patent application no: PCT/IB2023/057386, filed on: 20 Jul. 2023, titled: “ERGONOMIC LAPTOP COMPUTER SYSTEM WITH AUTOMATICALLY ADJUSTABLE SCREEN” and is incorporated herein by reference.

### BACKGROUND OF THE INVENTION

### Technical Field

The present disclosure relates to systems and more specifically to an ergonomic laptop computer system with automatically adjustable screen.

### Related Art

Ergonomics is the process of designing or arranging workplaces, products, and systems so that they fit the people who use them. For example, an ergonomic computer system for a user preferably should have the top of the monitor (display screen) level with the eyes of the user, with the monitor being about a user arm's length away from the user. The keyboard of the computer system should be at elbow level and enables the user's wrists to be in a straight line with the forearm of the user. In addition, the computer system should be placed such a way that the user can maintain a neutral head position, the shoulders of the user are relaxed and the back of the user is straight, the elbows of the user are close to the body at a 90°-100° (degree) angle, there is support for the natural back arch, the hip and knee of the user is at an angle of 90°-100°, and that the feet of the user are flat on the ground. This setup will allow the user to maintain health postures especially for neck and upper limb and thereby reducing the risk of musculoskeletal disorders and visual problems.

Such type of ergonomic setup is possible in a desktop computer because the display screen/monitor and keyboard are independent units and could be positioned as per the above recommended standards.

Laptop systems refer to personal computer system that can be easily moved and used in a variety of locations. In other words, portability is main differentiator between laptop systems and desktop systems. However, such portability typically necessitates that laptop systems be integrated units with the display screen and keyboard attached and inseparable.

In such laptop system, if the top of the display screen is positioned at the eyelevel, then the keyboard will be too high. But in most cases, users of the laptop systems position the keyboard at the elbow level (hereinafter referred to as “base”). As a result, the display screen will be very low and necessitates the user to excessively flex his/her neck to view the screen which is considered as a high-risk posture for neck disorders.

Therefore, there is a need to have a laptop computer system that could overcome the drawbacks noted above. Several aspects of the present invention are directed to an ergonomic laptop computer system with automatically adjustable screen as described in detail below.

### SUMMARY OF THE INVENTION

An ergonomic laptop/portable computer system is provided according to an aspect of the present invention. In an embodiment, the ergonomic portable computer system comprises a processing unit, an input unit placed on a base and a display system comprising a display screen whose height from the base and the distance from a user can be adjusted, the display system operating to ensure that the height and distance are according to one or more ergonomic standards.

In one embodiment, the one or more ergonomic standards include positioning the display screen at a height slightly below the eye-level of the user and at a one-arm distance from the user. Accordingly, the ergonomic laptop helps the users to adopt a healthy neck and upper limb postures and thereby reduces the risk of Musculo-skeletal disorders in individual users.

According to another aspect of the present invention, the display system (noted above) comprises one or more sensors to measure a first position of the display screen with respect to the user, a comparator to determine a first height and a first distance of the display screen based on the first position, and to identify that the first height and first distance are not in compliance with the one or more ergonomic standards and one or more actuators to cause the display screen to move to a second position whose height and distance is in compliance with the one or more ergonomic standards.

Thus, users are facilitated to adjust the height and distance of the laptop display screen in-relation to the input unit/keyboard automatically to recommended ergonomic standards (screen at a distance of one arm and height slightly below the eye level) based on the information obtained by the sensors.

According to one more aspect of the present invention, the one or more sensors comprise one or more of ultrasonic scanners and cameras.

According to yet another aspect of the present invention, the one or more actuators comprises a vertical actuator that controls the height of the display screen, a horizontal actuator that controls the distance of the display screen and a hinge actuator that controls the angle of the display screen with respect to the base. In one embodiment, the horizontal actuator is first activated to cause the change in the distance of the display screen, after which the vertical actuator is activated to cause the change in the height of the display screen. Such a sequence ensures that the ergonomic portable computer system is always balanced and would not topple/tip over.

According to an aspect of the present invention, the display system (noted above) comprises an actuator controller that facilitates the user to perform manual adjustments to the position of the display screen using one or more of arrow keys provided in the input unit or voice commands issued via a microphone attached to the processing unit.

According to another aspect of the present invention, the one or more actuators ensures that the height and distance of the display screen can be changed only up to a maximum height and maximum distance respectively.

According to one more aspect of the present invention, the display system (noted above) comprises an ON/OFF button. Pressing the ON/OFF button when the display system is in OFF state causes the display screen to be opened to an initial position and one or more sensors in the display system to be activated, the initial position being at a 90° angle from the base. Pressing the ON/OFF button when the display system is in ON state causes the display screen to be brought back to the initial position thereby enabling the portable computer system to be closed.

According to yet another aspect of the present invention, the display system (noted above) comprises a data connector to facilitate wired or wireless communication of data between the processing unit and the display screen.

According to another aspect of the present invention, the display system (noted above) comprises a power connector to receive power from a power supply or the processing unit and provide the power to the other components of the display system.

According to an aspect of the present invention, an ergonomic portable computer system comprising a processing unit, an input unit placed on a base and a display system comprising a display screen, performs the method of: measuring, using one or more sensors provided in the display system, a first position of the display screen with respect to a user; determining, based on the first position, a first height of the display screen from the base and a first distance of the display screen from the user; identifying that the first height and first distance are not in compliance with one or more ergonomic standards; and causing, using one or more actuators provided in the display screen, the display screen to move to a second position whose height and distance is in compliance with the one or more ergonomic standards.

According to one more aspect of the present invention, the system (noted above) further performs the method of: receiving from the user, manual adjustments to the position of the display screen using one or more of arrow keys provided in the input unit or voice commands issued via a microphone attached to the processing unit; and performing the manual adjustments, wherein the one or more actuators (noted above) ensures that the height and distance of the display screen can be changed only up to a maximum height and maximum distance respectively.

According to yet another aspect of the present invention, the display system comprises an ON/OFF button, with the system (noted above) performing the method of: receiving an indication of the user pressing the ON/OFF button; checking, in response to the indication, whether the display system is in ON state or OFF state; if the display system is in OFF state, causing the display screen to be opened to an initial position and the one or more sensors in the display system to be activated, the initial position being at a 90° angle from the base; and if display system is in ON state, causing the display screen to be brought back to the initial position thereby enabling the portable computer system to be closed.

According to another aspect of the present invention, a non-transitory machine-readable medium stores one or more sequences of instructions, which upon execution by a processing unit contained in an ergonomic portable computer system causes the system to perform the actions of: measuring, using one or more sensors provided in a display system comprising a display screen, a first position of the display screen with respect to a user; determining, based on the first position, a first height of the display screen from the base and a first distance of the display screen from the user; identifying that the first height and first distance are not in compliance with one or more ergonomic standards; and causing, using one or more actuators provided in the display screen, the display screen to move to a second position whose height and distance is in compliance with the one or more ergonomic standards.

Several aspects of the invention are described below with reference to examples for illustration. However, one skilled in the relevant art will recognize that the disclosed embodiments can be practiced without one or more of the specific details or with other methods, components, materials and so forth. In other instances, well-known structures, materials, or operations are not shown in detail to avoid obscuring the features of the disclosed embodiments. Furthermore, the features/aspects described can be practiced in various combinations, though only some of the combinations are described herein for conciseness.

### BRIEF DESCRIPTION OF THE DRAWINGS

Example embodiments of the present invention will be described with reference to the accompanying drawings briefly described below.

FIG. 1 is a block diagram illustrating an example laptop/portable computer system in which various aspects of the present invention are implemented.

FIG. 2 is a block diagram illustrating an implementation of an autonomous ergonomically aligning display system according to several aspects of the present invention.

FIGS. 3A-3E illustrates the manner in which an ergonomic laptop/portable computer system is implemented in one embodiment.

FIG. 4 is a flow chart illustrating the operation of an autonomous ergonomically aligning display system according to aspects of the present invention.

FIGS. 5A-5B illustrates the differences in the posture of a user between a traditional laptop and an ergonomic laptop provided according to several aspects of the present invention.

FIG. 6 is a block diagram illustrating the details of a digital processing system in which various aspects of the present invention are operative by execution of appropriate execution modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE DISCLOSED EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

The use of “including”, “comprising”, or “having” and variations there of herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

As used herein, the singular forms “a”, “an”, and “the” include both singular and plural referents unless the context clearly dictates otherwise. By way of example, “a dosage” refers to one or more than one dosage. The terms “comprising”, “comprises” and “comprised of” as used herein are synonymous with “including”, “includes” or “containing”, “contains”, and are inclusive or open-ended and do not exclude additional, non-recited members, elements, or method steps.

All documents cited in the present specification are hereby incorporated by reference in their totality. In particular, the teachings of all documents herein specifically referred to are incorporated by reference.

Example embodiments of the present invention are described with reference to the accompanying figures.

### 1. Example Laptop System

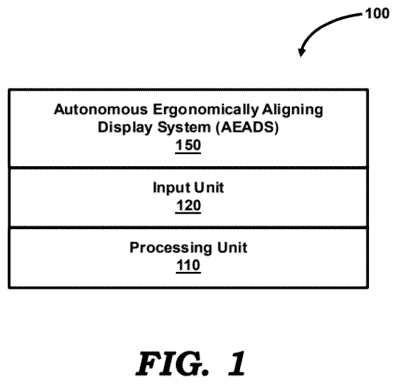

FIG. 1 is a block diagram illustrating an example laptop computer system (100) in which various aspects of the present invention are implemented. The block diagram is shown containing processing unit 110, input unit 120, and Autonomous Ergonomically Aligning Display System (AEADS) 150. Each of the blocks of FIG. 1 is described in detail below.

Processing unit 110 refers to the component of laptop computer system 100 that controls the interpretation and execution of instructions. Processing unit 110 may perform logical and arithmetical operations on the data as specified in the instructions. Processing unit 110 may contain one or more processors (such as a central processing unit (CPU)), random access memory (RAM), secondary memory, graphics controller, network/input interfaces, buses, power supply units, etc. as is well known in the relevant arts.

Input unit 120 facilitates users to provide inputs (e.g., instructions, data, etc.) to processing unit 110. In one embodiment, input unit 120 contains a keyboard and a pointing device (e.g., touch-pad, mouse), which enable the various inputs to be provided.

AEADS 150 represents an output device that displays information in pictorial or textual form. For example, AEADS 150 may receive data from processing unit 110 and provide an output in the form of characters or graphics representing the received data. An example AEADS 150 is described in detail below.

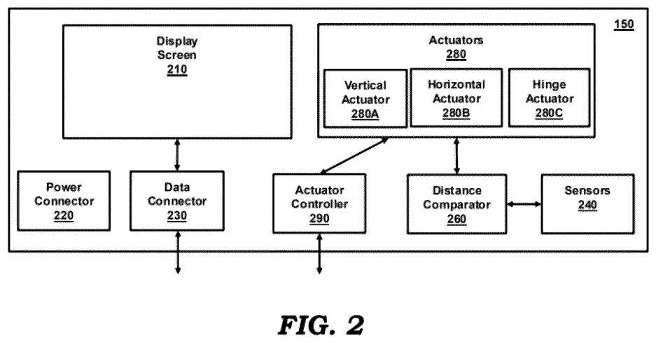

FIG. 2 is a block diagram illustrating an implementation of an autonomous ergonomically aligning display system (150) according to several aspects of the present invention. AEADS 150 is shown containing display screen 210, power connector 220, data connector 230, sensors 240, distance comparator 260, actuators 280 (in turn shown containing vertical/lifting actuator 280A, horizontal actuator 280B and hinge actuator 280C) and actuator controller 290. Each of the blocks of FIG. 2 is described in detail below.

Display screen 210 (or commonly referred to as a “monitor”) is a hardware device that shows a rendered electronic image made up of pixels that are illuminated in a way that distinguishes text and graphic elements. Display screen 210 may be implemented based on Cathode ray tube (CRT), Liquid crystal display (LCD), Light-emitting diode (LED), etc. as is well known in the relevant arts. In some embodiments, display screen 210 may facilitate users to provide inputs as well, for example, when implemented as a touch screen.

Power connector 220 facilitates power to be provided to various other components of AEADS 150 noted above. In one embodiment, power connector 220 receives (via wired or wireless communication paths) power from power supply units in processing unit 110 and distributes the power to the components of AEADS 150. In one embodiment, the power connectivity between processing unit 110 and AEADS 150 is provided via spiral wires, which have the capacity to extend and allow AEADS 150 to move in both vertical and horizontal directions. Alternatively, power connector 220 may be connected to and receive power from an external power supply (e.g., electrical mains). In one embodiment, AEADS 150 includes a rechargeable Lithium-Ion battery that is charged by power connector 220.

Data connector 230 facilitates data to be sent/received between processing unit 110 and AEADS 150. For example, data connector 230 may receive data to be displayed from processing unit 110, processes the data and forward the processed data to display screen 210 for display. For such processing, data connector 230 may contain one or more graphics controllers/processors that generate display signals (e.g., in RGB format) to display screen 210 based on data/instructions received from processing unit 110, with display screen 210 then displays the images defined by the display signals. In addition, data connector 230 may receive inputs specified by users from display screen 210 and forward the received inputs to processing unit 110. The communication paths between data connector 230 and processing unit 110 may be wired or wireless (e.g., WIFI, Bluetooth™, etc.). In one embodiment, wireless communication path using Bluetooth™ technology is used to ensure that the connectivity is provide even when processing unit 110 and AEADS 150 are detached and moving from each other in both horizontal and vertical directions.

Sensors 240 facilitate the determination of the location of a user relative to display screen 210. Sensors 240 may be ultrasonic scanners that scan for the position of the head of the user. Alternatively, sensors 240 may be one or more cameras that capture the images of the user. Sensors 240 then forward the captured data (images, location, etc.) to distance comparator 260).

Distance comparator 260 determines one or more distances between the user and display screen 210 based on the data received from sensors 240. For example, distance comparator 260 may determine the distances based on the location of the user (received from sensors 240) and a location of display screen 210 maintained internally. Alternatively, distance comparator 260 may process the images received from sensors 240 using well-known image processing techniques to determine the distances.

Distance comparator 260 then compares the determined distances to one or more optimal distances recommended for ergonomic design. In one embodiment, distance comparator 260 identifies whether the distance between the user and display screen 210 is at one-arm (of a user) distance, and whether display screen 210 is at a height slightly below the eye-level of the user. It may be appreciated the one-arm distance of the user may be a predefined standardized value stored internally or may be dynamically received from the user, for example, via a user interface (not shown) provided on display screen 210.

If the determined distances are identified to be satisfying the ergonomic standards noted above, distance comparator 260 may move to a sleep/inactive mode for a pre-defined duration, after which distance comparator 260 may perform the above noted processing again (to cause the processing to be performed repeatedly at the pre-defined duration). However, if the determined distances are identified to not conform to the ergonomic standards, distance comparator 260 moves display screen 210 in the appropriate direction by issuing one or more commands to actuators 280. Each command may specify a direction (e.g., up, down, front/anterior, back/posterior) and a distance/angle (e.g., 10 mm, 4°) to be moved in the specified direction.

Actuators 280 facilitate the movement of display screen 210 in one or more directions. Each actuator may contain one or more stepper motors, appropriate gears, and circuitry to control the operation of the motors and gears, as is well known in the relevant arts. Actuators 280 receive commands from distance comparator 260, and move display screen 210 according to the direction and distance/angle specified in the received commands.

Vertical/lifting actuator 280A facilitates display screen 210 to be moved in the vertical direction in relation to the base (e.g., horizontal surface) on which input unit 120 (and in one embodiment processing unit 110) is placed. In one embodiment, the maximum vertical distance that display screen 210 can be moved is 300 mm above the base.

Horizontal actuator 280B facilitates display screen 210 to be moved in the horizontal direction in relation to input unit 120 (and in one embodiment processing unit 110), that is along the axis (e.g., horizontal axis) of the base noted above. Hinge actuator 280C facilitates the angle of the display screen 210 to be changed in relation to the base noted above.

It may be appreciated that vertical actuator 280A and hinge actuator 280C may be used to ensure that display screen 210 is at a height slightly below the eye-level of the user, while horizontal actuator 280B may be used to ensure that the distance between the user and display screen 210 is at one-arm (of a user) distance. In one embodiment, actuators 280 ensures that the height and distance of the display screen can be changed only up to a maximum height (300 mm) and maximum distance (300 mm) respectively. In one embodiment, horizontal actuator 280B is first activated to cause the change in the distance of display screen 210, after which vertical actuator 280A (and/or hinge actuator 280C) is activated to cause the change in the height of display screen 210. Such a sequence ensures that AEADS 150 is always balanced and would not topple/tip over. However, in alternative embodiments, any sequence of actuators (for example, horizontal, vertical, horizontal, vertical, hinge) may be activated to cause display screen 210 to be at the desired ergonomic standard.

Actuator controller 290 receives one or more instructions from processing unit 110 or input unit 120, converts the instructions to one or more commands and sends the commands to actuators 280, thereby enabling a user to manually control the location of display screen 210. Such manual control may be required when the user wishes to make fine adjustments to the position of display screen 210. In one embodiment, the user specifies the manual adjustments using arrow keys provided in input unit 120. In another embodiment, the user may give voice commands via a microphone attached to processing unit 110, which in turn may send instructions corresponding to the voice commands to actuator controller 290, thereby enabling the user to control the location of display screen 210 via voice commands.

Thus, an ergonomic laptop/portable computer system with automatically adjustable screen is provided according to several aspects of the present invention. The manner in which a laptop/portable computer system may be implemented according to the features of FIG. 2 is described in detail below.

### 2. Example Implementation

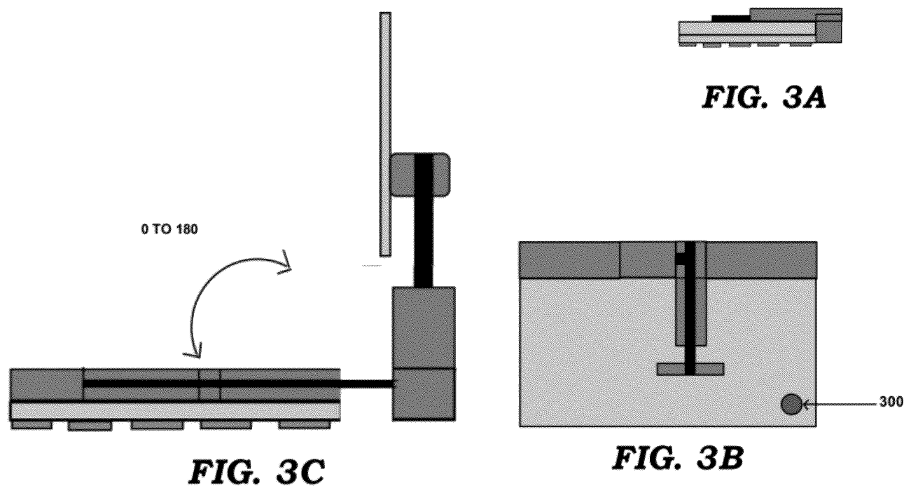

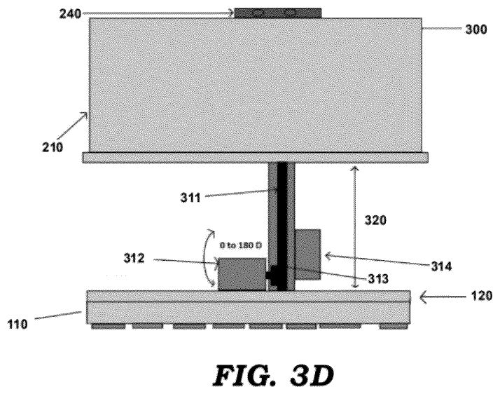

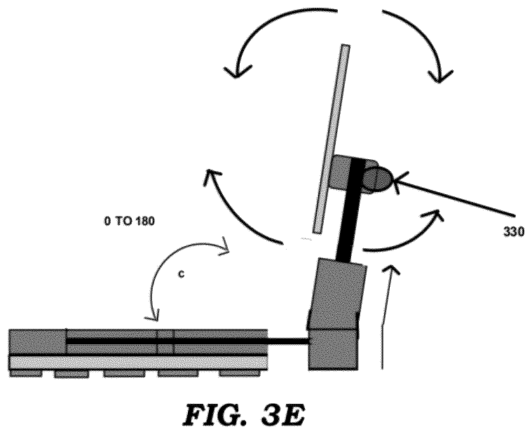

FIGS. 3A-3E illustrates the manner in which an ergonomic laptop/portable computer system is implemented in one embodiment. Each of the FIG.s is described in detail below.

FIG. 3A illustrates the ergonomic laptop system when folded/closed, according to several aspects of the present invention. It may be appreciated that the ergonomic laptop is compact and easy to carry similar to any other traditional laptop. The ergonomic laptop can be placed on a workstation desk such that input unit 120 (keyboard) is at a recommended comfortable position (base).

FIG. 3B illustrates a top view of the ergonomic laptop when folded/closed, according to several aspects of the present invention. Only ON/OFF button 300 is present on the top side of the ergonomic laptop. A user may press ON/OFF button 300 (when the laptop is in OFF state) so that stepper motor 312 (shown in FIG. 3D) is activated and results in the display screen flipping open to 90°, the initial position of the display screen. In one embodiment, once the laptop screen reaches the 90° initial positions, sensors 240 are activated.

The user may press ON/OFF button 300 when the ADS is in ON state to cause the display/laptop screen to be brought back to the initial position thereby enabling the portable computer system to be folded/closed.
FIG. 3C illustrates the ergonomic laptop when opened to the initial position, according to several aspects of the present invention. The display screen is shown being at 90° to the base, the initial position of the display screen.
FIG. 3D illustrates a front view of the ergonomic laptop when opened, according to several aspects of the present invention. It may be observed that sensors 240 are shown deployed at the top of the display/laptop screen. However, in alternative embodiments, the sensors may be deployed on the sides or bottom of display screen 210, as will be apparent to one skilled in the relevant arts by reading the disclosure herein. ON/OFF button 300 is also indicated to be at the back side of display screen 210.
The front view also shows shaft 311, stepper motor 312, gear setup 313 and actuator motor 314 that together operate to move display screen 210 either vertically or horizontally with respect to the base (the surface on which input unit 120 and processing unit 110 is shown placed). 320 indicate the maximum height (300 mm) to which display screen 210 can be moved.

Upon activation (when laptop screen is in initial position), sensors 240 (e.g., ultrasonic scanners) scan for the position of the head of the user and identifies that the position of display screen 210 is not according to ergonomic standards. Actuator motor 314 (12-inch movement in the anterioposterior direction with capacity to lift 15 Kgs) is activated, which in turn moves display screen 210 to one-arm distance away from the user. Once display screen 210 reaches the desired distance, stepper motor 312 (360° fully rotating model lifting capacity 25 kg) is activated which in turn raises the top display screen 210 to the eye level of the user (recommended position) as shown in FIG. 3E described below.
When the user presses ON/OFF button 300 when the laptop is ON state (after completion of a task), stepper motor 312 is first activated which in turn lowers the top digital screen to the initial position. Next, actuator motor 314 is activated which in turn moves display screen 210 back to the initial position, and then the laptop is folded back (to the state shown in FIG. 3A). In case of manual folding, a gear release mechanism (not shown) may be made readily available, so that the user can physically/manually fold the laptop to the folded/closed compact position.
Though not shown, an additional provision of reminding the user (e.g., by playing a buzzer sound) in case of any sustained deviation from the recommended head position may also be provided. In addition, a green indicator may be shown when the screen reaches optimum ergonomically recommended position like height slightly below eye level and one arm distance from the user. Also, if the user deviates from the ergonomic position, a reminder may be provided to revert to the optimum position.
FIG. 3E illustrates a side view of the ergonomic laptop when opened, according to several aspects of the present invention. 330 indicates the hinge adjustment mechanism that can be activated by hinge actuator 280C to control the angle of display screen 210 (screen tilt) with respect to the base. It may be observed that display screen 210 is shown moved in a horizontal direction to ensure that the display screen is at a one-arm distance from the user.
Thus, the ergonomic laptop described above enables a user to use a laptop system without compromising his/her health even in an extended use of the system. The ergonomic laptop is compact and easy to carry similar to any other traditional/conventional laptop system. The laptop screen can be flipped like any other traditional laptop system, with the additional provision of movement of the display screen in relation to the keyboard in both anteroposterior and superior inferior direction with a feature to tilt the screen to the desired angle. The manner in which AEADS 150 operates to provide several aspects of the present invention is described below with examples.

### 3. General Flow

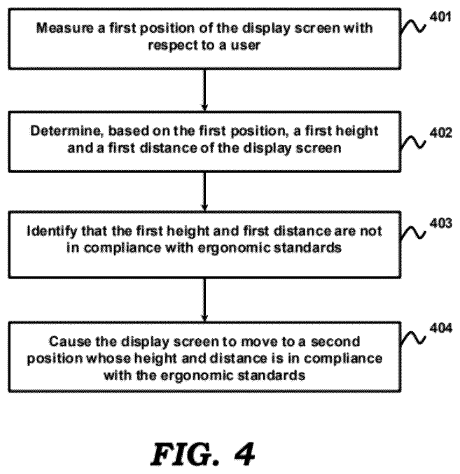

FIG. 4 is a flow chart illustrating the operation of an autonomous ergonomically aligning display system (150) according to aspects of the present invention. The flowchart is described with respect to FIGS. 1 and 2, in particular, AEADS 150, merely for illustration. However, various features can be implemented in other systems and/or other environments also without departing from the scope of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention.
In step 401, AEADS 150 measures a first position of the display screen with respect to a user. The measurement may be performed using one or more sensors 240 noted above.
In step 402, AEADS 150 determine, based on the first position, a first height and a first distance of the display screen. The first height is the distance between the display screen and the base, while the first distance is the distance between the display screen and the user. The determination may be performed by distance comparator 260 noted above.
In step 403, AEADS 150 identifies that the first height and first distance are not in compliance with ergonomic standards. The identification may be performed by distance comparator 260 noted above, for example, based on comparing the determined first height and first distance with corresponding height and distance recommended by the ergonomic standards.
In step 404, AEADS 150 causes the display screen to move to a second position whose height and distance is in compliance with the ergonomic standards. The movement of the display screen may be achieved using one or more actuators 280 noted above. As noted above, a horizontal actuator is first activated to cause the change in the distance of the display screen, after which a vertical actuator is activated to cause the change in the height of the display screen.

Thus, AEADS 150 operates to ensure that the height and distance (of display screen 210) are according to one or more ergonomic standards which include positioning the display screen at a height slightly below the eye-level of the user and at a one-arm distance from the user.

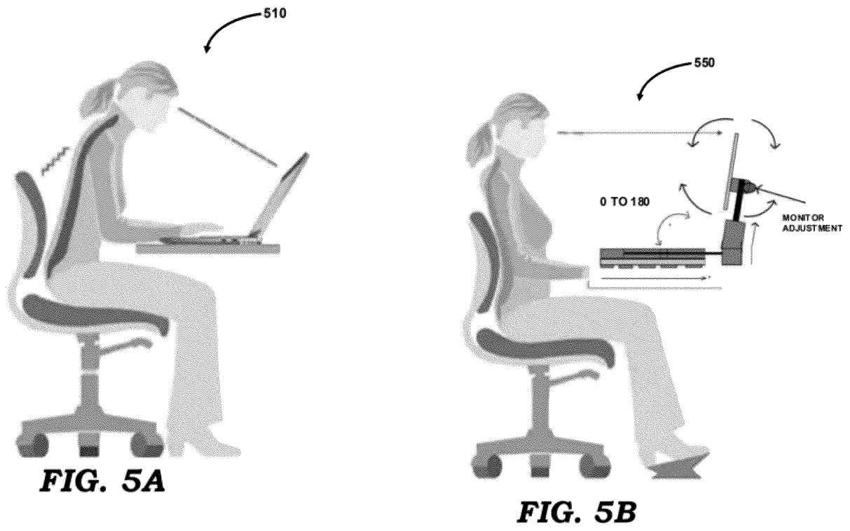

FIGS. 5A-5B illustrates the differences in the posture of a user between a traditional laptop and an ergonomic laptop provided according to several aspects of the present invention. 510 illustrates the abnormal neck posture of a user during traditional laptop use, while 550 illustrate the ergonomic recommended posture of the user during the use of the ergonomic laptop described herein.

The ergonomic laptop enables a user to use the laptop by adhering to the ergonomic recommendation of positioning the key board at the elbow height concurrently positioning the screen at the height slightly below the user's eyelevel and at a distance of one arm away from the user. This would reduce the risk of the development of musculoskeletal disorders especially in the neck region.

The ergonomic laptop could be replacement for the traditional laptop and serves all the other purposes at the same time without compromising the health of the users. The instant disclosed embodiments may provide a solution to laptop users who would be encountering posture-related and Musculo-skeletal issues

It should be appreciated that the above noted features can be implemented in various embodiments as a desired combination of one or more of hardware, execution modules and firmware. The description is continued with respect to one embodiment in which various features are operative when execution modules are executed.

### 4. Digital Processing System

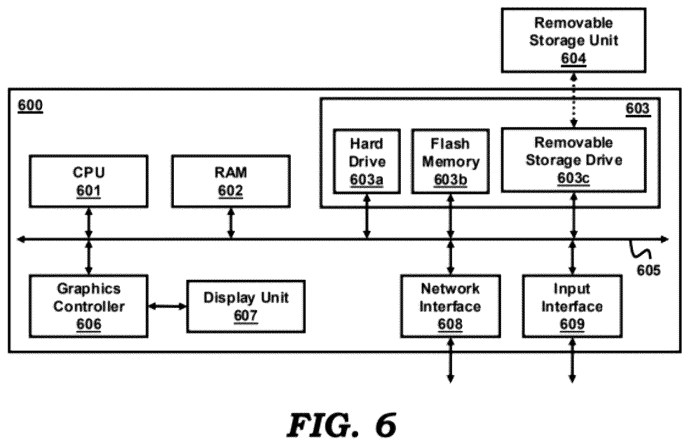

FIG. 6 is a block diagram illustrating the details of digital processing system 600 in which various aspects of the present invention are operative by execution of appropriate execution modules. Digital processing system 600 may correspond to AEADS 150.

Digital processing system 600 may contain one or more processors (such as a central processing unit (CPU) 601), random access memory (RAM) 602, secondary memory 603, graphics controller 606, display unit 607, network interface 608, and input interface 609. All the components except display unit 607 may communicate with each other over communication path 605 which may contain several buses as is well known in the relevant arts. The components of FIG. 6 are described below in further detail.

CPU 601 may execute instructions stored in RAM 602 to provide several features of the present invention. CPU 601 may contain multiple processing units, with each processing unit potentially being designed for a specific task. Alternatively, CPU 601 may contain only a single general-purpose processing unit. RAM 602 may receive instructions from secondary memory 603 using communication path 605.

Graphics controller 606 generates display signals (e.g., in RGB format) to display unit 607 based on data/instructions received from CPU 601. Display unit 607 contains a display screen to display the images defined by the display signals. Input interface 609 may correspond to a keyboard and a pointing device (e.g., touch-pad, mouse), which enable the various inputs to be provided.

Network interface 608 provides connectivity to a network (e.g., using Internet Protocol), and may be used to communicate with other connected systems. Network interface 608 may provide such connectivity over a wire (in the case of TCP/IP based communication) or wirelessly (in the case of WIFI, Bluetooth based communication).

Secondary memory 603 may contain hard drive 603a, flash memory 603b, and removable storage drive 603c. Secondary memory 603 may store the data and software instructions, which enable digital processing system 600 to provide several features in accordance with the present invention.

Some or all of the data and instructions may be provided on removable storage unit 604, and the data and instructions may be read and provided by removable storage drive 603c to CPU 601. Floppy drive, magnetic tape drive, CD-ROM drive, DVD Drive, Flash memory, and removable memory chip (PCMCIA Card, EPROM) are examples of such removable storage drive 603c.

Removable storage unit 604 may be implemented using storage format compatible with removable storage drive 603c such that removable storage drive 63c can read the data and instructions. Thus, removable storage unit 604 includes a computer readable storage medium having stored therein computer software (in the form of execution modules) and/or data.

However, the computer (or machine, in general) readable storage medium can be in other forms (e.g., non-removable, random access, etc.). These “computer program products” are means for providing execution modules to digital processing system 600. CPU 601 may retrieve the software instructions (forming the execution modules) and execute the instructions to provide various features of the present invention described above.

It should be understood that the figures and/or screen shots shown above highlighting the functionality and advantages of the present invention are presented for example purposes only. The present invention is sufficiently flexible and configurable, such that it may be utilized in ways other than that shown in the figures.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the disclosed embodiments have been shown and described in detail to illustrate the inventive principles, it will be understood that the disclosed embodiments may be embodied otherwise without departing from such principles.

It should be understood that the examples and embodiments described herein are for illustrative purposes only and that various modifications or changes in light thereof will be suggested to persons skilled in the art and are to be included within the spirit and purview of this application and scope of the appended claims.

I/We claim:

1. An ergonomic portable computer system comprising:
a processing unit (110);
an input unit (120) placed on a base; and
a display system (150) comprising a display screen (210) whose height from the base and the distance from a user can be adjusted, wherein the display system operates to ensure that the height and distance are according to one or more ergonomic standards.

2. The ergonomic portable computer system of claim 1, wherein the one or more ergonomic standards include positioning the display screen at a height slightly below the eye-level of the user and at a one-arm distance from the user.

3. The ergonomic portable computer system of claim 1, wherein the display system comprises:
one or more sensors (240) to measure a first position of the display screen with respect to the user;
a comparator (260) to determine a first height and a first distance of the display screen based on the first position, and to identify that the first height and first distance are not in compliance with the one or more ergonomic standards; and
one or more actuators (280) to cause the display screen to move to a second position whose height and distance is in compliance with the one or more ergonomic standards.

4. The ergonomic portable computer system of claim 3, wherein the one or more sensors comprises one or more of ultrasonic scanners and cameras.

5. The ergonomic portable computer system of claim 3, wherein the one or more actuators comprises a vertical actuator (280A) that controls the height of the display screen, a horizontal actuator (280B) that controls the distance of the display screen and a hinge actuator (280C) that controls the angle of the display screen with respect to the base.

6. The ergonomic portable computer system of claim 3, wherein the display system comprises an actuator controller (290) that facilitates the user to perform manual adjustments to the position of the display screen using one or more of arrow keys provided in the input unit or voice commands issued via a microphone attached to the processing unit.

7. The ergonomic portable computer system of claim 1, wherein the one or more actuators (280) ensures that the height and distance of the display screen can be changed only up to a maximum height and maximum distance respectively.

8. The ergonomic portable computer system of claim 1, wherein the display system comprises an ON/OFF button (312),
wherein pressing the ON/OFF button when the display system is in OFF state causes the display screen to be opened to an initial position and one or more sensors in the display system to be activated, the initial position being at a 90° angle from the base,
wherein pressing the ON/OFF button when the display system is in ON state causes the display screen to be brought back to the initial position thereby enabling the portable computer system to be closed.

9. The ergonomic portable computer system of claim 1, wherein the display system comprises a data connector (230) to facilitate wired or wireless communication of data between the processing unit and the display screen.

10. The ergonomic portable computer system of claim 1, wherein the display system comprises a power connector (220) to receive power from a power supply or the processing unit and provide the power to the other components of the display system.

11. A method performed in an ergonomic portable computer system comprising a processing unit (110), an input unit (120) placed on a base and a display system (150) comprising a display screen (210), the method comprising:
measuring, using one or more sensors (240) provided in the display system, a first position of the display screen with respect to a user;
determining, based on the first position, a first height of the display screen from the base and a first distance of the display screen from the user;
identifying that the first height and first distance are not in compliance with one or more ergonomic standards; and
causing, using one or more actuators (280) provided in the display screen, the display screen to move to a second position whose height and distance is in compliance with the one or more ergonomic standards.

12. The method of claim 11, wherein the one or more ergonomic standards include positioning the display screen at a height slightly below the eye-level of the user and at a one-arm distance from the user.

13. The method of claim 11, wherein the one or more sensors comprises one or more of ultrasonic scanners and cameras,
wherein the one or more actuators comprises a vertical actuator (280A) that controls the height of the display screen, a horizontal actuator (280B) that controls the distance of the display screen and a hinge actuator (280C) that controls the angle of the display screen with respect to the base.

14. The method of claim 11, further comprising:
receiving from the user, manual adjustments to the position of the display screen using one or more of arrow keys provided in the input unit or voice commands issued via a microphone attached to the processing unit; and
performing the manual adjustments, wherein the one or more actuators (280) ensures that the height and distance of the display screen can be changed only up to a maximum height and maximum distance respectively.

15. The method of claim 11, wherein the display system comprises an ON/OFF button (312), the method further comprising:
receiving an indication of the user pressing the ON/OFF button;
checking, in response to the indication, whether the display system is in ON state or OFF state;
if the display system is in OFF state, causing the display screen to be opened to an initial position and the one or more sensors in the display system to be activated, the initial position being at a 90° angle from the base; and
if display system is in ON state, causing the display screen to be brought back to the initial position thereby enabling the portable computer system to be closed.

16. A non-transitory machine-readable medium storing one or more sequences of instructions, wherein execution of said one or more instructions by a processing unit (110) contained in an ergonomic portable computer system (100) causes the system to perform the actions of:
measuring, using one or more sensors (240) provided in a display system (150) comprising a display screen (210), a first position of the display screen with respect to a user;
determining, based on the first position, a first height of the display screen from the base and a first distance of the display screen from the user;
identifying that the first height and first distance are not in compliance with one or more ergonomic standards; and
causing, using one or more actuators (280) provided in the display screen, the display screen to move to a second position whose height and distance is in compliance with the one or more ergonomic standards.

17. The non-transitory machine-readable medium of claim 16, wherein the one or more ergonomic standards include positioning the display screen at a height slightly below the eye-level of the user and at a one-arm distance from the user.

18. The non-transitory machine-readable medium of claim 16, wherein the one or more sensors comprises one or more of ultrasonic scanners and cameras,
wherein the one or more actuators comprises a vertical actuator (280A) that controls the height of the display screen, a horizontal actuator (280B) that controls the distance of the display screen and a hinge actuator (280C) that controls the angle of the display screen with respect to the base.

19. The non-transitory machine-readable medium of claim 16, further comprising one or more instructions for:
receiving from the user, manual adjustments to the position of the display screen using one or more of arrow keys provided in an input unit (120) or voice commands issued via a microphone attached to the processing unit; and
performing the manual adjustments, wherein the one or more actuators (280) ensures that the height and distance of the display screen can be changed only up to a maximum height and maximum distance respectively.

20. The non-transitory machine-readable medium of claim 16, wherein the display system comprises an ON/OFF button (312), further comprising one or more instructions for:
receiving an indication of the user pressing the ON/OFF button;
checking, in response to the indication, whether the display system is in ON state or OFF state;
if the display system is in OFF state, causing the display screen to be opened to an initial position and the one or more sensors in the display system to be activated, the initial position being at a 90° angle from the base; and
if display system is in ON state, causing the display screen to be brought back to the initial position thereby enabling the portable computer system to be closed.
